(19) United States
(12) Patent Application Publication
(10) Pub. No.: US 2007/0199237 A1
(43) Pub. Date: Aug. 30, 2007

(54) SOIL FUMIGATION METHOD AND APPARATUS

(76) Inventor: Clare Elise BROADBENT, Caboolture, Queensland (AU)

Correspondence Address: PATENTTM.US, P. O. BOX 82788, PORTLAND, OR, 97282-0788, US

(21) Appl. No.: 11/565,482

(22) Filed: Nov. 30, 2006

Related U.S. Application Data
(60) Provisional application No. 60/741,133, filed on Nov. 30, 2005.

(51) Int. Cl. A01M 13/00; A01M 1/20

(52) U.S. Cl. 43/125; 43/124; 43/132.1

(57) ABSTRACT

A soil fumigation apparatus (10), suitable for the treatment of the soil (20) below a building slab (30) for termites, has an injector assembly (40) with an injection head (50) connectable to a supply of fumigating chemical(s), the injection head (50) being connected to one or more chemical distributors (60) each having a plurality of outlets (65) to distribute the fumigating chemicals to the soil (20).

### BACKGROUND OF THE INVENTION

1. Field of the Invention

THIS INVENTION relates to a soil fumigation method and apparatus. The invention particularly relates, but is not limited to, the sub-soil injection of chemicals for fumigation and poisoning of pests such as termites and ants.

2. Prior Art

In many areas, it is obligatory to treat the sub-soil below houses or other building constructions with a fumigant or other liquid chemical(s) for the purpose of eradicating termites and/or other pests.

In recent years, environmental concerns have resulted in legislation banning highly toxic chemicals and requiring the use of less toxic chemicals, which have no long-term adverse environmental effects.

To enable effective fumigation of the soil, to prevent the return of the termites or other pests when the toxicity of the chemicals has become degraded, it has been necessary to re-inject the chemical(s) into the soil to maintain, eg., an effective barrier against termite infestation.

Typically, the chemicals must be re-injected into the sub-soil every 3-5 years.

A major difficulty arises in ensuring a total, even, distribution of the injected chemical(s) under, eg., the floor slab of the house or building to be protected. This is of particular difficulty where the original floor slab did not incorporate injection apparatus for the chemicals when the floor slab was installed.

Furthermore, existing injection equipment only enabled injection of the chemical(s) under the floor slab within their local vicinity, ie., it was not possible to use the injection equipment to inject the chemical(s) under a floor slab at a relatively remote location.

### SUMMARY OF THE PRESENT INVENTION

It is an object of the present invention to provide a soil fumigation method where fumigating chemicals may be injected into the soil under a floor slab or like building construction before or after the floor slab is established.

It is a preferred object of the present invention to provide a fumigation method which can ensure that the injection of the formula(s) is effected in an even distribution about an injection point.

It is a further preferred object of the present invention to provide a soil fumigation method where a single injection apparatus which may be employed to enable chemical(s) to be injected at one or more remote locations under the floor slab.

It is a still further preferred object of the present invention to provide a soil fumigation apparatus for carrying out the method.

Other preferred objects of the present invention will become apparent from the following description.

In one aspect, the present invention resides in a method for soil fumigation, where fumigating or other chemical(s) is/are injected under a floor slab or other building construction, including the steps of:

a) placing a housing of an injector assembly in a hole in a floor slab (or like building construction);

b) locating at least one chemical distributor in the soil below the floor slab;

c) connecting the or each chemical distributor to the injector assembly; and

d) supplying fumigating chemical(s) to the injector assembly for flow to the chemical distributor(s) for distribution in the soil about the chemical distributor(s).

In a second aspect, the present invention resides in soil fumigation apparatus including:

an injector assembly having a housing receivable in a hole in a floor slab or other building construction;

at least one chemical distributor locatable in soil below the floor slab; and

pipe means connecting the or each chemical distributor to the injector assembly; wherein:

fumigating chemical(s) supplied to the injector assembly can operably flow to the chemical distributor(s) for distribution in the soil about the chemical distributor(s).

Preferably, the housing has a bottom wall surrounded by an annular side wall and surmounted by a peripheral flange, the side wall being receivable within a hole in the floor slab and the peripheral flange engaging the floor slab about the hole for support.

Preferably, a removable cover is received in an annular seat to close the housing.

Preferably, an injection head is provided within the housing and is operable to receive the fumigating chemical(s), preferably supplied under pressure via a hose, preferably having a quick-release fitting complementary to the injection head.

Preferably, the chemical distributor has a hollow body defining a chamber with an inlet at one end and a plurality of chemical outlets, preferably equally-radially spaced, connected to the other end of the chamber.

Preferably, the inlet sealably engages one end of the pipe or hose, operably connected to an outlet of the injection head.

Where two or more of the chemical distributors are connected to a single injection head, the respective pipe or hose for each may be connected to an intermediate T-piece or like single inlet/multiple outlet connector operably connected to the outlet of the injection head.

The chemical distributor may be located below, or remote from, the injection assembly and preferably evenly distributes the fumigating chemical(s) in a soil zone about the chemical distributor. Preferably, a plurality of the chemical distributors are provided under the floor slab, with overlapping fumigating zones so that all the soil under the floor slab is fully fumigated.

### BRIEF DESCRIPTION OF THE DRAWINGS

To enable the invention to be fully understood, preferred embodiments will now be described with reference to the accompanying drawings in which:

FIG. 1 is a part-schematic sectional side view of a first embodiment of the present invention;

FIG. 2 is a sectional side view of the chemical distributor taken on line 2-2,

FIG. 3 is a schematic part-sectional side view of a second embodiment of the invention;

FIG. 4 is a schematic top plan view of the second embodiment;

FIG. 5 is a schematic part-sectional side view of a third embodiment of the present invention; and

FIG. 6 is a schematic top plan view of the third embodiment.

### DETAILED DESCRIPTION OF THE PREFERRED EMBODIMENTS

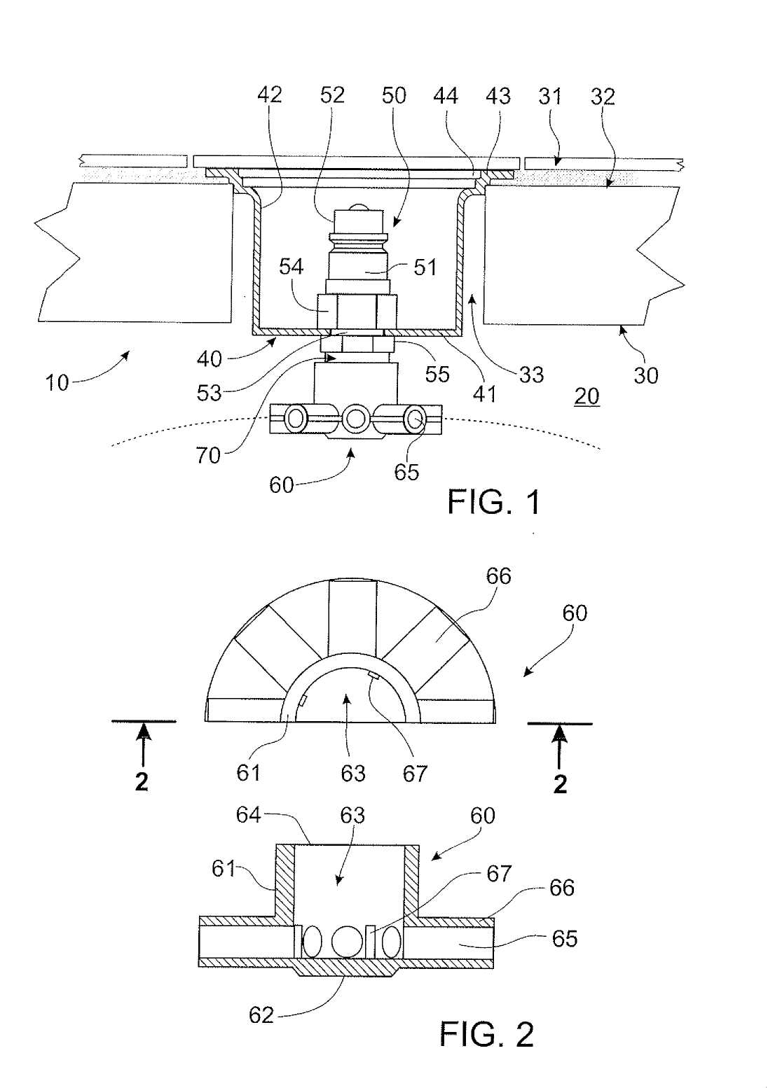

Referring to FIGS. 1 and 2, the fumigation apparatus 10 has been designed for fumigation of the soil 20 below a slab 30, eg., a floor slab over which is laid floor tiles 31 on a grout bed 32.

A hole 33 has been cut in the slab to receive the housing 40 for an injection head 50, which is operably connected to a chemical distributor 60 (to be hereinafter described in more detail with reference to FIG. 2).

The injector assembly housing 40 has a bottom wall 41 surrounded by a side wall 42 which is provided with a peripheral flange 43 with an external profile to enable the housing 41 to be supported in the hole 33 by the surrounding portion of the slab 30.

The housing may be closed by one of the floor tiles 31 or by a cover engaged in an annular seat 44 adjacent the peripheral flange 43.

The injection head 50 has a body 51 with an inlet end 52 adapted for quick release connection to a hose (not shown) connected to a source of the fumigating chemical(s) under pressure. The outlet end 53 of the injection head 50 passes through a hole in the housing wall 41 and is secured by clamping nuts 54, 55.

The chemical distributor 60 has an annular wall 61 and an end wall 62 to define a chamber 63 having an inlet 64 at one end.

A plurality of outlets 65 are provided at equal radial spacings about the chamber 63 and are defined by outlet tubes 66.

Inwardly-directed flanges 67 limit the insertion of connecting pipe 70 into the chamber 63 to ensure that the connecting pipe 70 does not wholly or partially close the outlets 65.

The connecting pipe 70 is received in close engagement with the inlet 64 of the chamber 63 and is preferably sealably secured thereto, eg., by suitable plumbing adhesive. The other end of the connecting pipe 70 is connected to the outlet 53 of the injection head 50.

By connecting a hose to the inlet 52 of the injection head 50 and pumping the fumigating chemical(s) under pressure through the injection head 50, the chemical(s) flows through the connecting pipe 70 to the chemical distributor 60 and is evenly distributed in the adjacent soil 20 to provide an effective barrier against termites or other pests.

In an alternative embodiment not shown, the injector assembly may be pre-located before the slab 30 is poured, the side wall 41 of the housing 40 acting as formwork for the slab 30 about the injection assembly.

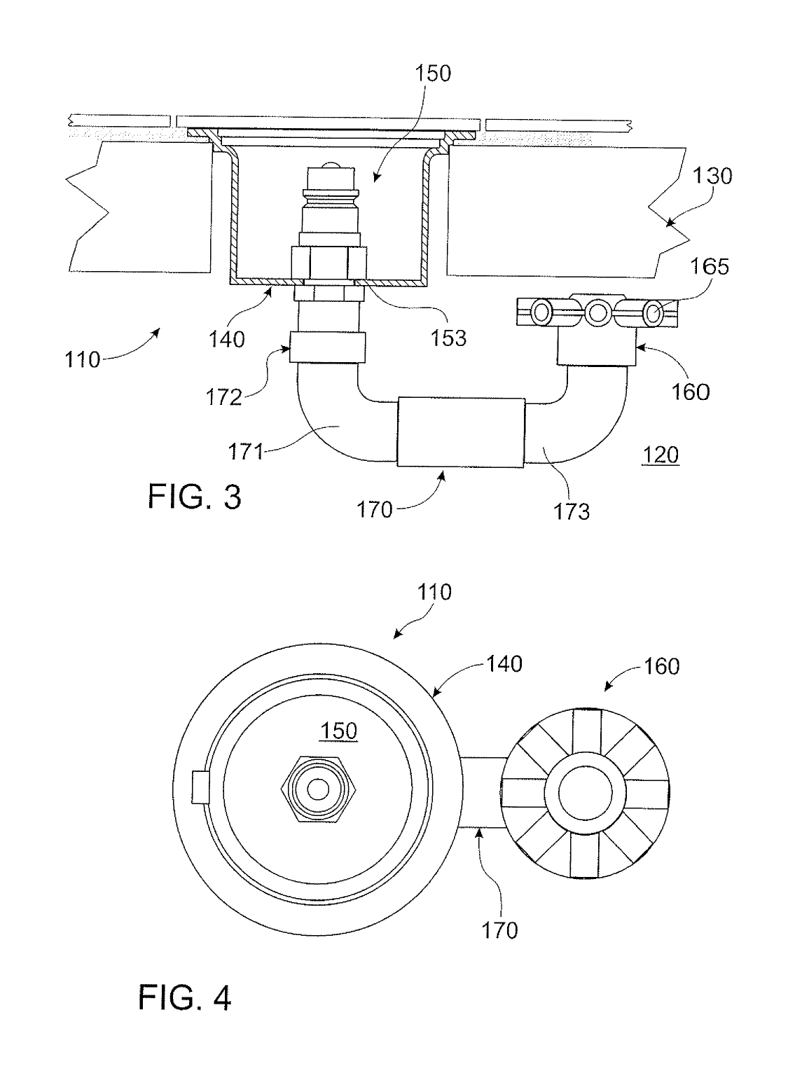

In the second embodiment illustrated in FIGS. 3 and 4, the chemical distributor 160 is offset in the soil 120, under the slab 130, relative to the housing 140 of the injection head 150.

The connecting pipe 170 is connected to the outlets 153 of the injection head 150 by an elbow 171 and connector 172; while the connecting pipe 170 is connected to the chemical distributor 160 by a second elbow 173.

It will be readily apparent to the skilled addressee that the chemical distributor 160 may be provided below the second elbow 173 and that the length of the connecting pipe 170 may be varied to vary the relative offset of the chemical distributor 160 to the housing 140 for the injection assembly 110.

Such an arrangement is also possible to provide the injector assembly 110 within the slab and locate the chemical distributor 160 at adjacent the side or end edge of the slab 130, eg., where the slab is an external patio, verandah or pathway.

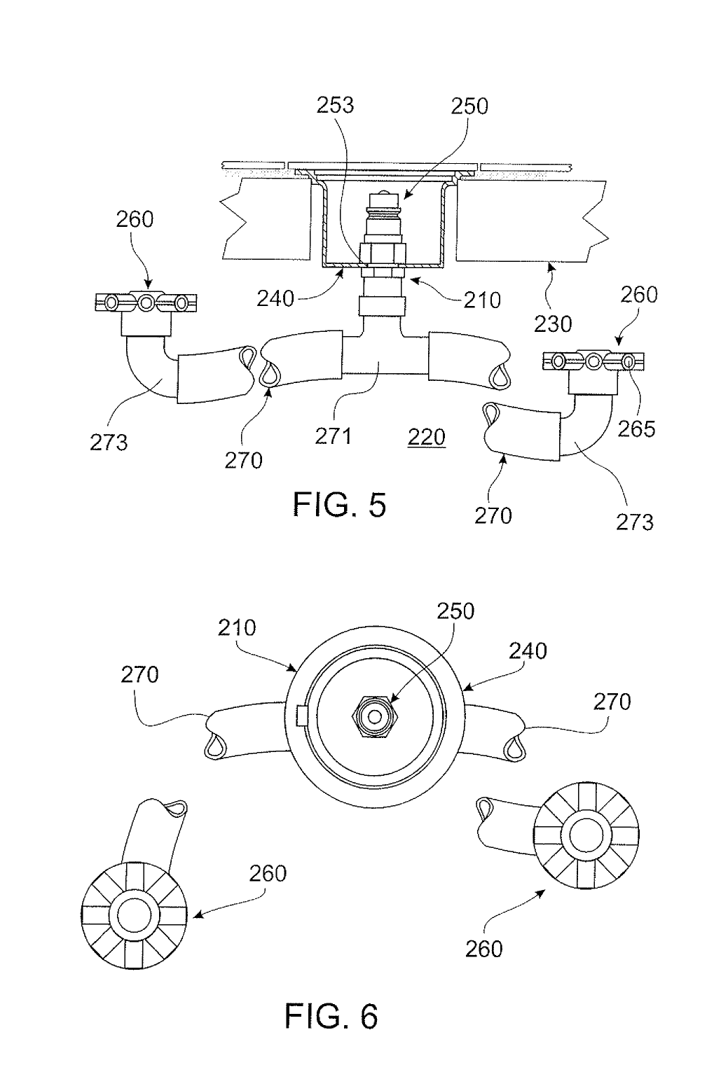

In the third embodiment of FIGS. 5 and 6, a single injector assembly 210 can be connected to two (or more) chemical distributors 260 which can be provided at a number of alternative locations, relative to the housing 240 for the injection head 250, to enable fumigation of the soil 220 below the slab 230. In this embodiment, respective connecting hoses 270 are connected via elbows 273 to chemical distributors 260 and to a T-piece connector 271 connected to the outlet 253 of the injection head 250.

It will be readily apparent to the skilled addressee that the T-piece connector 271 may be replaced by a connector having one inlet/three or more outlets, each provided with connecting hoses 270, connected to respective chemical distributors 260.

The chemical distributors 60, 160, 260 will be located under the slabs 30, 130, 230, so that the respective zones which they fumigate in the soil 20, 120, 220 will fully overlap to ensure complete and full fumigation of the soil 20, 120, 220.

While the chemical distributors 60, 160, 260 have been shown with outlets 65, 165, 265, to provide a 360° injection pattern around the chemical distributors 60, 160, 260, it will be readily apparent to the skilled addressee that the chemical injector 60 may be modified so as to have outlets 65 arranged to distribute the chemical(s) about a 180° zone—see as for FIG. 2.

Such a 180° distribution pattern may be employed where a garden bed is laid adjacent the slab 30, 130, 230, eg., along a pathway, verandah or patio, and it is desired that the fumigating chemical(s) not be injected into the soil in the region of the garden bed.

The ability to be able to cut a hole 33 in an existing slab 30 and to insert the fumigation assembly 10, 110, 210, into the hole 33 in the slab 30, 130, 230, with the chemical distributors 60, 160, 260 in the soil 20, 120, 220, below the slab 30, 130, 230, enables fumigation of the soil 20, 120, 220 after the slab 30, 130, 230 has been installed.

Alternatively, fumigation assembly 10, 110, 210 may be located in the formwork before the slab 30, 130, 230 is poured for new houses or other building constructions.

The respective components are preferably manufactured from chemical-resistant plastics materials, eg., PVC, and will have a long life, enabling periodic injection of the fumigating chemical(s) under the slabs 30, 130, 230, eg., every 3-5 years. This ensures that an effective barrier, eg., against termites, is maintained in the soil 20, 120, 220 under the slabs 30, 130, 230 as the toxicity of the fumigating chemical(s) degrades with time.

Various changes and modifications may be made to the embodiments described and illustrated without departing from the present invention as defined in the appended claims.

I claim:

1. A method for soil fumigation, where at least one fumigating chemical is injected under a floor slab or building construction, including the steps of:
a) placing a housing of an injector assembly in a hole in a floor slab or building construction;
b) locating at least one chemical distributor in the soil below the floor slab or building construction;
c) connecting the or each chemical distributor to the injector assembly; and
d) supplying the or each fumigating chemical to the injector assembly for flow to the or each chemical distributor for distribution in the soil about the or each chemical distributor.

2. Soil fumigation apparatus including:
an injector assembly having a housing receivable in a hole in a floor slab or building construction;
at least one chemical distributor locatable in soil below the floor slab or building construction;
pipe means connecting the or each chemical distributor to the injector assembly; and
at least one fumigating chemical supplied to the injector assembly operably flowable to the or each chemical distributor for distribution in the soil about the or each chemical distributor.

3. An apparatus as claimed in claim 2, wherein:
the housing has a bottom wall surrounded by an annular side wall and surmounted by a peripheral flange, the side wall being receivable within a hole in the floor slab or building construction and the peripheral flange engaging the floor slab or building construction about the hole for support.

4. An apparatus as claimed in claim 3, wherein:
a removable cover is received in an annular seat to close the housing.

5. An apparatus as claimed in claim 2, wherein:
an injection head is provided within the housing and is operable to receive the or each fumigating chemical supplied under pressure via a hose having a quick-release fitting complementary to the injection head.

6. An apparatus as claimed in claim 2, wherein:
the chemical distributor has a hollow body defining a chamber with an inlet at one end and a plurality of chemical outlets, substantially equally-radially spaced, connected to an end of the chamber.

7. An apparatus as claimed in claim 6, wherein:
the inlet sealably engages one end of the pipe or hose, operably connected to an outlet of the injection head.

8. An apparatus as claimed in claim 2, wherein:
two or more of the chemical distributors are connected to a single injection head, and the respective pipe means or hose for each chemical distributor is connected to an intermediate T-piece or a single inlet/multiple outlet connector operably connected to the outlet of the injection head.

9. An apparatus as claimed in claim 2, wherein:
the chemical distributor is located below, or remote from, the injection assembly and substantially evenly distributes the or each fumigating chemical in a soil zone about the chemical distributor.

10. An apparatus as claimed in claim 9, wherein:
a plurality of the chemical distributors are provided under the floor slab or building construction, with overlapping fumigating zones so that all the soil under the floor slab or building construction is fully fumigated.
